(19) United States
(12) Patent Application Publication
(10) Pub. No.: US 2008/0231206 A1
(43) Pub. Date: Sep. 25, 2008

(54) Method and Ballast for Driving a High-Pressure Gas Discharge Lamp

(75) Inventors: Winston Donald Couwenberg, Eindhoven (NL); Robertus Antonius Johannes Keijser, Eindhoven (NL); Jacobus Marinus Maria Claassens, Eindhoven (NL); Bennie Izaak Pieter Simpelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 10/597,421

(22) PCT Filed: Jan. 18, 2005
(86) PCT No.: PCT/IB2005/050209

§ 371 Date: Jul. 25, 2006

(30) Foreign Application Priority Data
Jan. 28, 2004 (EP) 04100287.4
Feb. 18, 2004 (EP) 04100641.2

(51) Int. Cl. H05B 41/24; H05B 41/36

(52) U.S. Cl. 315/248; 315/291

(57) ABSTRACT

Method of driving a high-pressure gas discharge lamp during its steady-state operation, wherein a steady-state current signal is sent through the lamp for maintaining a discharge arc in the lamp, comprising the step of comparing the lamp conductivity response to a current step in said current signal with reference parameters; and in response to said comparison at least one of the following steps: stopping the current supply to the lamp, generating a signal indicating the end-of-life status of the lamp, changing the steady-state current through the lamp, changing the steady-state waveform of the current signal through the lamp, and generating a signal indicating the lamp type, wherein said current step is obtained by sending a current pulse which is superimposed on said steady-state current signal through the lamp.

The invention relates to a method of driving a high-pressure gas discharge lamp during its steady-state operation, wherein a steady-state current signal is sent through the lamp for maintaining an arc in the lamp, comprising the step of comparing the lamp voltage response to a current step in said current signal with reference parameters; and in response to said comparison at least one of the following steps: stopping the power supply to the lamp, generating a signal indicating the end-of-life status of the lamp, generating a signal representing the lamp type, changing the steady-state current (intensity) through the lamp, and changing the steady-state waveform of the current signal through the lamp.

Such a method was disclosed by K. Günther of OSRAM GmbH during the Seventh International Symposium on the Science & Technology of Light Sources, held from 27 to 31 Aug. 1995 in Kyoto, Japan, and is described on pages 93 to 100 of the Symposium Proceedings, published in 1995 by The Illuminating Engineering Institute of Japan. The teachings of this document are incorporated herein by reference, in particular the teaching concerning the correlation between the electrical conductivity of the lamp and its photometric properties, as well as the teaching concerning response signal processing and analysis.

In said Symposium Proceedings it is suggested to detect the radiation properties of the lamp by analyzing the electrical conductivity response in a pulsed mode operation ballast, or in the case of a metal halide lamp by applying a power step to the lamp and measuring the decay or rise time of the conductivity response. The first alternative is limited in its application to said pulsed operation mode, while the second alternative influences the operation of the lamp such that the intensity of the lamp will increase or decrease.

The object of the invention is to analyze the lamp conductivity response to a power step in such a way that the method is applicable to a broad range of operation modes, while the intensity or color temperature of the lamp remains unchanged or alternatively can be changed in a controlled manner.

According to the invention, said power step is obtained by sending a current pulse which is superimposed on the steady-state current signal through the lamp.

Said steady-state current signal may then have any form, for instance a perfect sinusoidal form or a pure DC, or combinations thereof. Furthermore, the duration of the superimposed pulse may be shorter than the decay or rise time of the voltage response (typically 10 μs-1.5 ms) of a current step in the aforementioned known alternative would be, and rather than measuring the decay or rise time of the voltage response the form of the response may be analyzed.

In a first preferred embodiment, the duration of said pulse is preferably shorter than the duration of the half period of the AC current component of the steady-state current signal. The superimposed pulse may also be a negative pulse, or a “dip” in the signal.

In a second preferred embodiment, for instance in a high-frequency operation mode, the duration of said pulse is a multiple of the duration of the period of the AC current component of the steady-state current signal, wherein preferably the pulse is formed by a temporarily intensified amplitude of said AC current component of the steady-state current signal.

Preferably, the step of comparing the voltage response comprises measuring the decay time of the voltage and comparing it with a reference decay time, or analyzing the shape of the response signal and comparing it with reference values.

In a further preferred embodiment, the step of changing the steady-state waveform comprises the step of superimposing a recurring power pulse on said steady-state waveform which is, for example, a square or sinusoidal wave, for example for changing the color temperature of the lamp. In this manner the waveform is changed to a more complex recurring form which has an effect on the color temperature of the lamp without necessarily having much influence on the intensity of the lamp.

The invention further relates to a ballast for driving a high-pressure gas discharge lamp comprising power supply means for sending a steady-state current signal through the lamp for maintaining an arc in the lamp, response comparing means for comparing the lamp voltage response to a current step in said current signal with reference parameters; and responding means for stopping the power supply to the lamp, generating a signal indicating the end-of-life status of the lamp, generating a signal indicating the lamp type, changing the steady-state current through the lamp, and/or changing the steady-state waveform of the current signal through the lamp in response to said comparison, wherein said ballast further comprises pulse means for sending a current pulse which is superimposed on said steady-state current signal through the lamp for obtaining said current step. Means for implementing the aforementioned preferred method embodiments may be comprised in said ballast, whether separately or in combination.

An embodiment of the present invention will now be described, by way of example only, with reference to the accompanying drawings, in which:

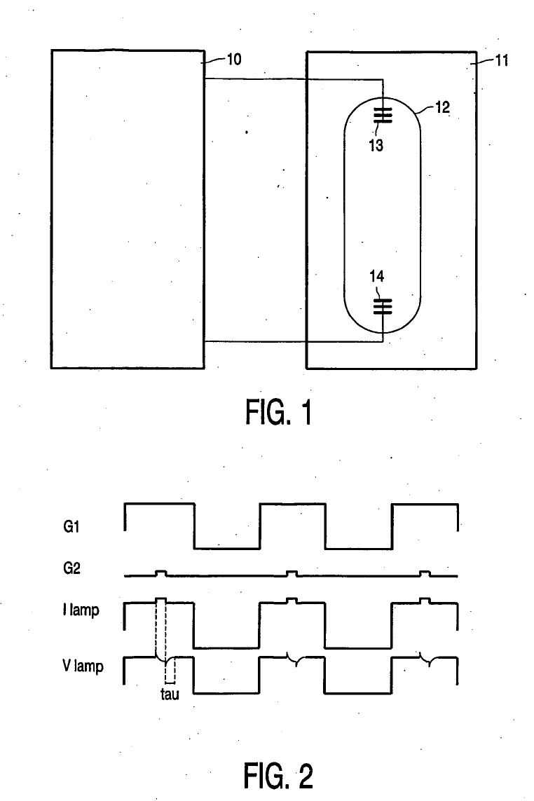

FIG. 1 shows a ballast and lamp configuration;

FIG. 2 shows an example of a steady-state square waveform, a recurring pulse, the combined signal, and its dynamic voltage response used in the method according to the invention; and

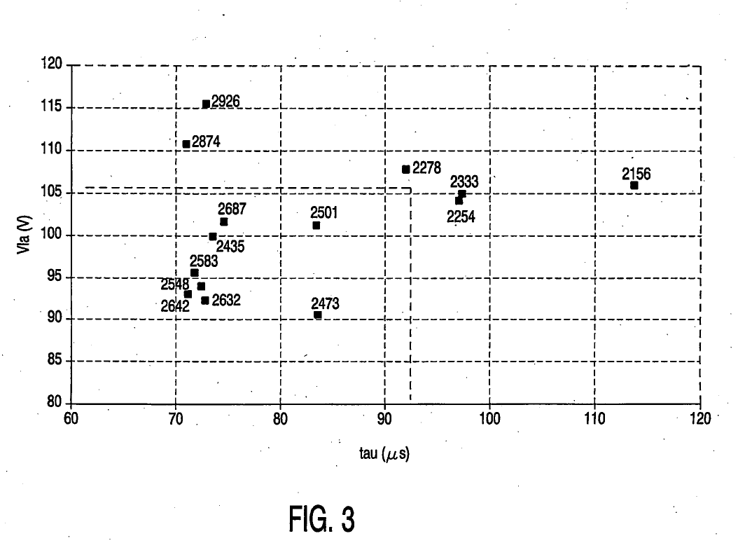

FIG. 3 plots various white HPS lamp examples of different ages having different color temperature values as indicated against their dynamic voltage response decay times (tau) as well as the lamp voltages (Vla).

With reference to FIG. 1, an electronic ballast 10 is connected to a high-pressure gas discharge lamp 11 which contains an arc tube 12 having electrodes 13, 14 sealed into opposing ends of arc tube 12. The first electrode 13 is connected to one terminal of ballast 10, and the remaining electrode 14 is connected to the remaining terminal of ballast 10.

In particular White HPS lamps suffer from a loss of sodium from the amalgam fill in the arc tube owing to corrosion or diffusion during life, which leads to a lower color temperature of the lamp. White HPS lamps require some form of electronic control to keep the color of the lamps within acceptable limits. A control algorithm used in practice is based on the existence of a correlation between the color temperature of the lamp and the lamp voltage. This correlation is based on the fact that both the spectral distribution and the electrical characteristics are directly determined by the Na and Hg vapor pressures. This, however, holds only in the case of a well-defined relation between these vapor pressures, which is only the case for a fixed amalgam composition. It fails in a situation where, for example, the amalgam composition changes as a result of Na corrosion or diffusion as the lamp ages. The impact of Na corrosion processes—even at the high Na vapor pressures in this type of lamp—can be suppressed sufficiently to obtain an adequate lamp life. However, as the lamp ages, a point will ultimately be reached where the Na loss becomes significant. The consequence of this is that the known color control approach based on a sensing of the steady-state electrical lamp characteristics has to fail. For old lamps (with severe loss of Na) a large drop in the color temperature is observed as compared with lamps of the same lamp voltage, resulting in an unacceptable yellowish appearance of the lamp. It was one object of the invention to detect this decreased color temperature in order to determine the end of life of the lamp 11 if the color temperature is below an acceptable limit, without the need for optical measuring instruments such as photo diodes.

Therefore, according to FIG. 2, a short (1.4 ms wide) current power pulse (G2) is superimposed on the steady-state low-frequency (90 Hz) square-wave current signal (G1) of an electronic ballast operating 100 W white HPS lamps, resulting in a combined current signal (I lamp). Then the dynamic response of the lamp voltage (V lamp) is detected by the electronic circuit of the ballast 10 and a characteristic decay or rise time (tau) can be determined. The decay time will in general vary in the range between about 1 μs and about 1.5 ms.

It is apparent from FIG. 3 that the response time, in particular the decay or rise time (tau), in response to the applied power pulse is longer for lamps with sodium loss (having a lower color temperature).

It is also apparent from FIG. 3 that lamps 11 having a higher than normal color temperature show a higher lamp voltage (Vla), related to a higher cold spot temperature of the lamp 11, which is a known effect (see for instance European patent application EP-A-2281123). However, lamps having a lower than average color temperature equally show a higher lamp voltage (Vla), as can be seen in FIG. 3. An additional evaluation of the voltage response to a current pulse renders it possible to distinguish the two types of deviation from each other.

In the present example, lamps complying with Vla>105 V AND tau<90 μs could be identified as having a too high color temperature (>2700 K), whereas lamps complying with tau>90 μs could be identified as having a too low color temperature (<2400 K).

The lamp 11 can be switched off in reaction to said identification. It is also possible, for example in a high aspect ratio HID burner with a sodium cerium filling, to influence the color temperature of the lamp 11 in reaction to and in dependence on the determined value of tau. This may be done, for example by adding a sufficiently high unidirectional direct-current component to the alternating current and/or by superimposing a sufficiently high and wide recurring pulse to the current. Preferably, such a recurring pulse which is applied for changing the color temperature of the lamp is at the same time used to trigger the aforementioned voltage response.

It was found that both measures, adding a DC current component and current pulses, can influence the color temperature of various types of high-pressure gas discharge lamps 11, and that it can be applied in a controlled manner by using appropriate control circuitry in the ballast, which will, however, be apparent to those skilled in the art.

1. Method of driving a high-pressure gas discharge lamp (11) during its steady-state operation, wherein a steady-state current signal (G1) is sent through the lamp (11) for maintaining an arc in the lamp (11), comprising the step of comparing the lamp voltage response (Vlamp) to a current step in said current signal with reference parameters; and in response to said comparison at least one of the following steps: stopping the power supply to the lamp (11), generating a signal indicating the end of life status of the lamp (11), changing the steady-state current through the lamp (11), changing the steady-state waveform of the current signal through the lamp (11), and generating a signal indicating the lamp type, characterized in that said current step is obtained by sending a current pulse (G2) which is superimposed on said steady-state current signal (G1) through the lamp (11).

2. Method according to claim 1, wherein the steady-state current signal (G1) comprises an alternating current component.

3. Method according to claim 2, wherein the duration of said pulse (G2) is shorter than the duration of the half period of the AC current component or the half period of the AC current signal of the steady-state current signal (G1).

4. Method according to claim 1, 2 or 3, wherein the superimposed pulse (G2) is a negative pulse.

5. Method according to claim 2, wherein the duration of said pulse (G2) is a multiple of the duration of the period of the AC current component of the steady-state power signal (G1), and wherein preferably the pulse (G2) is comprised of a temporarily intensified amplitude of said AC current component of the steady-state power signal (G1).

6. Method according to any of the previous claims 1 to 4, wherein the step of comparing the voltage response (Vlamp) comprises measuring the decay or rise time (tau) of the voltage and comparing it with a reference decay or rise time.

7. Method according to any of the previous claims 1 to 4, wherein the step of comparing the voltage response (Vlamp) comprises analyzing the shape of the response signal and comparing it with reference values.

8. Method according to any of the previous claims 1 to 4, wherein the step of changing the steady-state waveform (G1) comprises the step of superimposing a recurring current pulse (G2) on said steady-state waveform.

9. Ballast (10) for driving a high-pressure gas discharge lamp (11), comprising power supply means for sending a steady-state current signal (G1) through the lamp (11) for maintaining an arc in the lamp (11), response comparing means for comparing the lamp voltage response (Vlamp) to a current step in said current signal with reference parameters; and responding means for stopping the power supply to the lamp (11), generating a signal indicating the end-of-life status of the lamp (11), generating a signal indicating the lamp type, changing the steady-state current through the lamp (11), and/or changing the steady-state waveform of the current signal through the lamp (11) in response to said comparison, characterized in that said ballast (10) further comprises pulse means for sending a current pulse (G2) which is superimposed on said steady-state current signal (G1) through the lamp (11) for obtaining said current step.
